(19) United States
(12) Patent Application Publication
(10) Pub. No.: US 2017/0317536 A1
(43) Pub. Date: Nov. 2, 2017

(54) INDUCTIVE POWER TRANSMITTER

(71) Applicant: PowerbyProxi Limited, Freemans Bay (NZ)

(72) Inventors: Paul David MARSON, Freemans Bay (NZ); Lewis Freeth HARPHAM, Freemans Bay (NZ); Zachary Strachan HARRIS, Freemans Bay (NZ)

(21) Appl. No.: 15/526,200

(22) PCT Filed: Nov. 11, 2015
(86) PCT No.: PCT/NZ2015/050188

§ 371 Date: May 11, 2017

Related U.S. Application Data
(60) Provisional application No. 62/078,103, filed on Nov. 11, 2014.
(60) Provisional application No. 62/094,341, filed on Dec. 19, 2014.
(60) Provisional application No. 62/099,750, filed on Jan. 5, 2015.
(60) Provisional application No. 62/251,643, filed on Nov. 5, 2015.

(51) Int. Cl. H02J 50/60; G01V 3/10; H02J 50/12

(52) U.S. Cl. CPC H02J 50/60; H02J 50/12; G01V 3/10

(57) ABSTRACT

An object detection system 200 for an inductive power transmitter and comprising: an excitation coil 202; a detection coil 204; the system arranged to determine a measure of complex impedance at the detection coil 204 in response to application of an excitation current to the excitation coil 202; the system further arranged to detect the presence of an object and a type of the object using the measure of complex impedance.

### FIELD

This invention relates generally to an inductive power transmitter, particularly, but not exclusively, for an inductive power transfer system.

### BACKGROUND

IPT systems are a well-known area of established technology (for example, wireless charging of electric toothbrushes) and developing technology (for example, wireless charging of handheld devices on a ‘charging mat’). Typically, a power transmitter generates a time-varying magnetic field from a transmitting coil or coils. This magnetic field induces an alternating current in a suitable receiving coil in a power receiver that can then be used to charge a battery, or power a device or other load.

Regarding IPT systems for wireless charging of handheld devices in particular it is important that the wireless power is transferred to the receiver device only and not to so-called foreign objects, which can be defined as any object that is positioned on the charging mat (e.g., interface surface), but is not part of a receiver device. Typical examples of such foreign objects are parasitic elements containing metals such as coins, keys, paperclips, etc. For example if a parasitic metal is close to the active IPT area it could heat up during power transfer due to eddy currents that result from the oscillating magnetic field. In order to prevent the temperature of such parasitic metal from rising to unacceptable levels, the power transmitter should be able to discriminate between power receivers and foreign objects and timely abort the power transfer.

A conventional manner of detecting heating of foreign objects on an interface surface uses a power loss method. In this method the received power P_{PR} is used to indicate the total amount of power that is dissipated within the power receiver contained in the handheld device due to the magnetic field produced by the power transmitter. The received power equals the power that is available from the output of the power receiver plus any power that is lost in producing that output power. The power receiver communicates its P_{PR} to the power transmitter so that the power transmitter can determine whether the power loss is within acceptable set limits, and if not, the power transmitter determines anomalous behaviour which may indicate presence of a foreign object and aborts power transmission. However, this power loss accounting method does not in itself provide actual detection of a foreign object, only the occurrence of non-expected behaviour.

International patent publication number WO2014/095722, by contrast, proposes a method of foreign object detection which uses excitation and detection coils within the transmitter, separate from the primary IPT transmitter coil(s). In that case either changes in the output voltage in the detection winding, or changes in the inductance of the detection winding are used to determine possible presence of an object. However this system requires a complex calibration to determine the base inductance. It is also insensitive to metal objects versus ferrous or magnetic objects, and therefore does not provide a means to discriminate between foreign objects and friendly objects, e.g., a receiver device. Any undesirable effects of operation of the primary IPT field on the detection is also not considered or characterised, such that the proposed method may be unreliable.

It is an object of the invention to provide the public with a useful choice.

### SUMMARY

According to one example embodiment there is provided an inductive power transmitter comprising:

At least one transmitting coil configured to generate an inductive power transfer (IPT) field; and an object detection system configured to detect objects in or adjacent to the IPT field;

wherein the object detection system is substantially decoupled from the IPT field.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a schematic diagram of an inductive power transfer system;

FIG. 2 is a block diagram of an object detection system;

FIG. 3 is a schematic diagram of a double OD coil;

FIG. 4 is a schematic diagram of a single OD coil;

FIG. 5 is a schematic diagram of another double OD coil;

FIG. 6 is a schematic diagram of a transmission coil layout;

FIG. 7 is a schematic diagram showing the OD and IPT coils interleaved around the ferrites;

FIG. 8 is a cross section of a PCB based OD coil;

FIG. 9 is a simulation of the flux lines generated by the excitation coil using the IPT ferrites;

FIG. 10A is a flow diagram of the detection algorithm;

FIG. 10B is a flow diagram of another detection algorithm;

FIG. 11 is a schematic diagram of an excitation coil driver;

FIG. 12 is a circuit diagram of the excitation coil driver;

FIG. 13 is a schematic diagram of a detector;

FIG. 14 is a circuit diagram of the multiplexer;

FIG. 15 is a circuit diagram of the mixer; and

FIG. 16 is a schematic diagram of a further embodiment.

### DETAILED DESCRIPTION

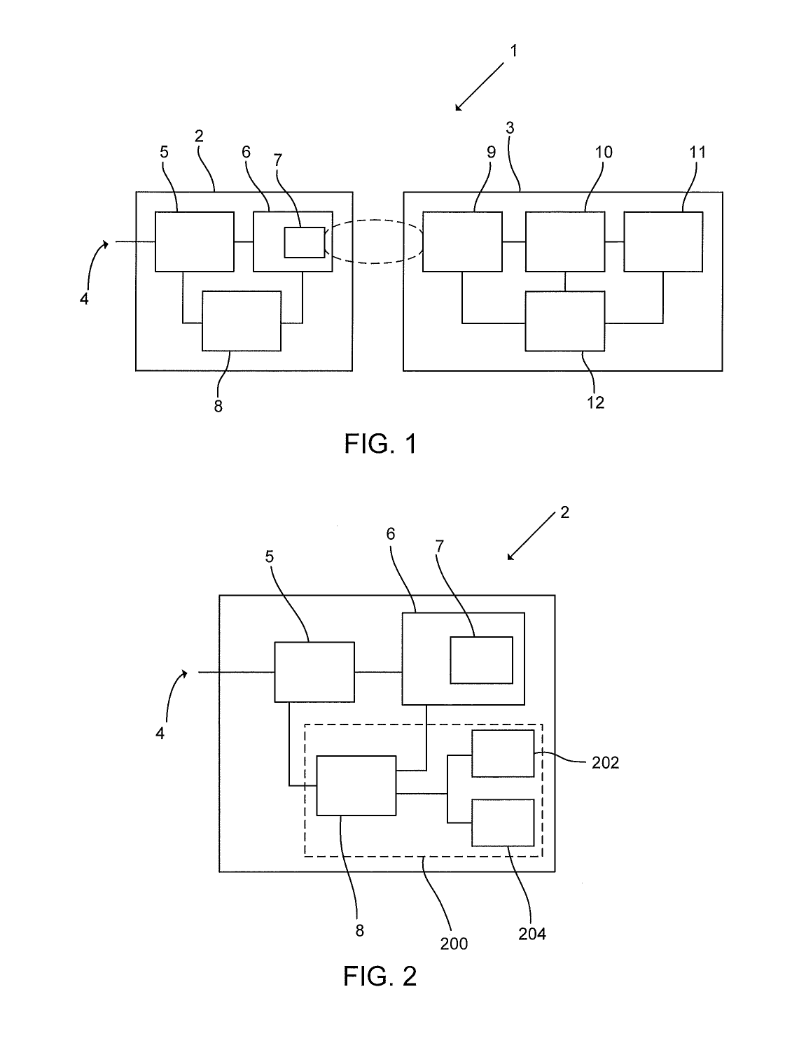

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit.

A controller 8 may be connected to each part of the inductive power transmitter 2. The controller 8 receives inputs from each part of the inductive power transmitter 2 and produces outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications. The controller 8 may internally include memory for storing measured and calculated data or may be connected to external memory for such purpose.

The inductive power receiver 3 includes a receiving coil or coils 9 connected to receiver circuitry which may include power conditioning circuitry 10 that in turn supplies power to a load 11. When the coils of the inductive power transmitter 2 and the inductive power receiver 3 are suitably coupled, the alternating magnetic field generated by the transmitting coil or coils 7 induces an alternating current in the receiving coil or coils 9. The power conditioning circuitry 10 is configured to convert the induced current into a form that is appropriate for the load 11, and may include for example a power rectifier, a power regulation circuit, or a combination of both. The receiving coil or coils 9 may be connected to capacitors (not shown) either in parallel or series to create a resonant circuit. In some inductive power receivers, the receiver may include a controller 12 which may control tuning of the receiving coil or coils 9, operation of the power conditioning circuitry 10 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. The use of the term “coil”, in either singular or plural, is not meant to be restrictive in this sense. Other configurations may be used depending on the application.

An example transmitter 2 is shown in FIG. 2. The inverter 6 supplies power to the transmitting coil 7 to generate an IPT field. An object detection (OD) circuit 200 includes an excitation coil or coils 202 to generate a detection (OD) field separate from the IPT field and a detection coil or coils 204 used to sense the presence and/or location of objects on or adjacent to the transmitter 2. The controller 8 of the transmitter 2 may either directly or via a separate control circuit be configured to determine the excitation to be provided to the excitation coil 202 and process the output signal from the detection coil 204.

This may involve a single excitation coil and an array of detection coils, an array of excitation coils and a single detection coil, an array of excitation coils and an array of detection coils, using a single coil for both excitation and detection, and/or using the IPT coil(s) as the excitation coil(s) (and either using the IPT frequency or modulating an excitation signal onto the IPT field) depending on the requirements of the application.

In an embodiment the detection technique may be considered a form of magnetic vision system, which works by transmission of an excitation signal to a power receiver (or other conducting object in the detection field) which is then scattered back to an array of sensors which are monitored either continuously or periodically. The strength and delay of the backscatter of the excitation signal is measured and may be separately analysed at each location across the array. This can then be used to detect objects (both friendly and foreign) and track the position and/or movement of such objects, such as multiple receivers, in the IPT field or on the transmitter surface. It may also be able to detect foreign objects which are overlapping with the friendly objects, such as the receiving coil(s) of a power receiver.

The detection array is structured such that its resolution is sufficient for significant foreign objects to be sensed or “seen” and located, with sufficient aperture to be able to identify the presence and location of one or more phones or perhaps a tablet or a portable PC or other portable rechargeable equipment.

One or more embodiments may rely on directly or indirectly determining the transfer of energy (either to an object or between the excitation coil and the detector coil) rather than a reflection. In other words the coupling coefficient between the excitation coil, the object and/or the detector coil is used to determine the nature and/or location of the object e.g.: foreign (or friendly).

Decoupling from the IPT Field

The OD field is used for detection of objects whereas the IPT filed is used to wirelessly transfer meaningful levels of power between electronic devices. Accordingly, the power of the IPT field is several orders of magnitude higher than the OD field, such that in order to effectively operate the object detection apparatus during power transfer it may be desirable to substantially decouple the OD field from the IPT field. A number of ways of achieving such decoupling are now described. In this way, any undesirable effects of operation of the IPT field on the detection are minimised, thereby making the detection method of the present invention more reliable and robust.

The OD field can be a produced so as to have a significantly higher or lower frequency than that used for the IPT field. This may allow frequency isolation from the IPT field as well as increasing the sensitivity of physically small objects, such as coinage, due to the possibility of resonance being set up in the object. For a common application of IPT, where the IPT field has an operating frequency is about 110 kHz to about 205 kHz, a OD field frequency that is higher in the MHz region, such as about 1 MHz or that is lower in the kHz region, such as about 5 kHz may be used. Such frequencies may also provide enhanced sensitivity for certain types of foreign objects. In this way the OD field is frequency decoupled from the IPT field.

Accordingly, in one embodiment the driving of the OD field is configured so that one OD field frequency is used for object detection where this frequency is lower or higher than the IPT field frequency, e.g., about 5 kHz or about 1 MHz. In an alternative embodiment driving of the OD field is configured so that a range of OD field frequencies are used, using so-called frequency “hopping” or “sweeping”. Several different frequencies may be used about the exemplary levels already described at which measurements for object detection are made. For example, for OD field frequencies higher than the IPT field frequency measurements may be taken at each of about 800 kHz, about 1 MHz and about 1.2 MHz, and for OD field frequencies lower than the IPT field frequency measurements may be taken at each of about 1 kHz, about 5 kHz and about 10 kHz. This frequency hopping advantageously provides the ability to increase discrimination between foreign and friendly objects. For example, for power receivers having the receiver coil(s) as part of a resonant circuit and non-resonant objects, e.g., metal or ferrite, may provide similar response to the OD field at a particular OD field frequency. This may occur due to the selected OD field frequency being a harmonic of the IPT field frequency, for example. However, such resonant receivers will provide a different response at different OD field frequencies whilst the response of non-resonant objects is substantially independent of frequency.

The excitation coil(s) 202 and/or the detection coil(s) 204 (collectively referred to as OD coils) may be arranged to approximately encompass a positive IPT flux and an equivalent negative IPT flux. In this way the OD field is substantially magnetically decoupled from the IPT field. This may be achieved in a number of ways. For example counter-wound (i.e., clockwise and counter-clockwise) OD coils may be used in symmetrical locations within the or each IPT transmitter coil (i.e., encompassed within the dimensions or ‘footprint’ of one transmitting coil above or below that coil with respect to the horizontal plane of that coil) with equal flux in each counter-wound OD coil. In a further example portions of each OD coil may be inside and outside of the IPT transmitter coil. In a still further example counter-wound OD coils may be used in asymmetrical portions of the IPT field produced by one or more transmitter coils with different numbers of turns (i.e., in a clockwise wound portion vs. a counter clockwise wound portion).

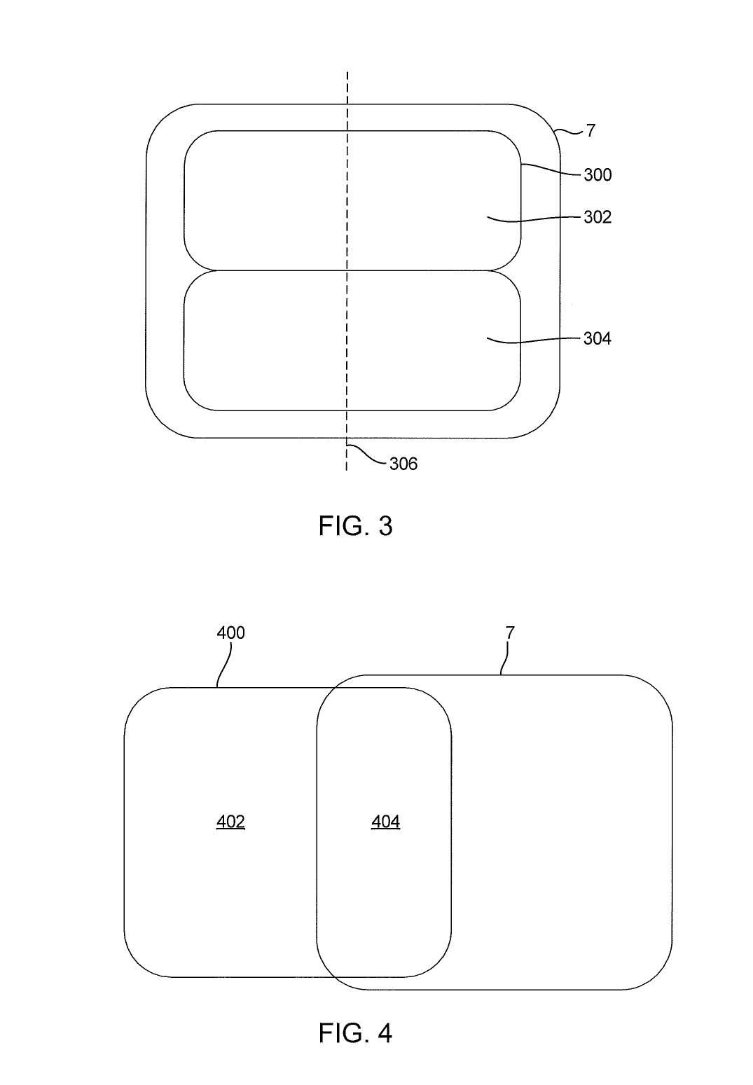

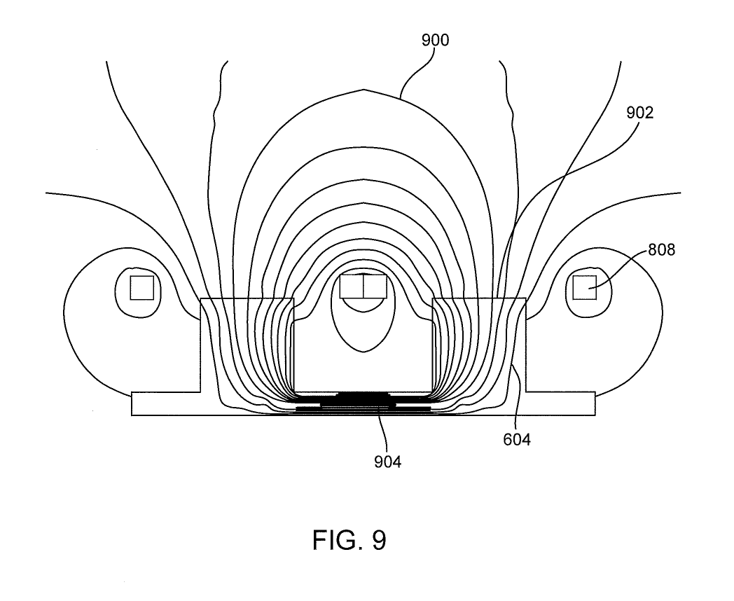

FIG. 3 shows an example of a double excitation/detection coil 300. The coil 300 has a clockwise wound portion 302 and a counter clockwise portion 304. The coil 300 is located wholly within one IPT transmitter coil 7 with the clockwise and counter-clockwise portions 302,304 positioned on either side of a line of symmetry 306 through the transmitter coil 7 so that equal amounts of IPT flux passes through each portion 302,304. In this example embodiment, the oppositely-wound portions 302,304 may be formed as separate windings that are coupled to one another in a manner understood by those skilled in the art or as a single winding wound in a (substantially symmetrical) “FIG. 8” configuration.

FIG. 4 shows an example of a single excitation/detection coil 400. The coil 400 has an outside (first) portion 402 and an inside (second) portion 404, with respect to one IPT transmitter coil 7. That is, coil 400 is arranged to overlap the transmitter coil 7 so that the outside portion 402 is arranged exterior to the IPT transmitter coil 7 whereas the inside portion 404 is arranged interior of the IPT transmitter coil 7, such that with equal amounts of (opposite) IPT flux passes through each portion 402,404.

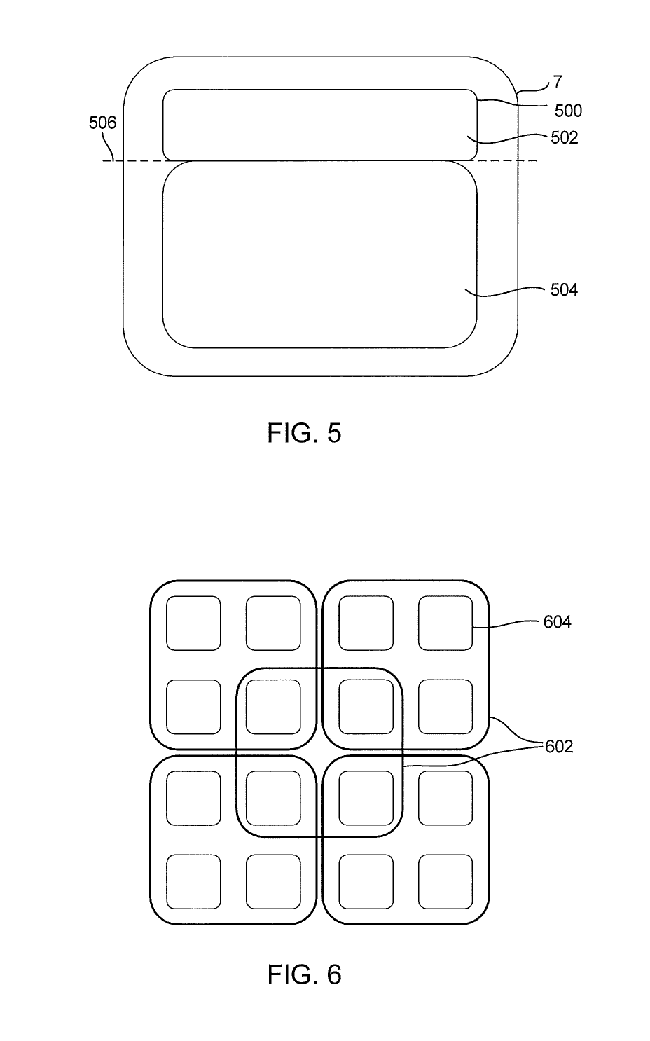

FIG. 5 shows an example of another double excitation/detection coil 500. The coil 500 has a clockwise wound portion 502 and a counter clockwise portion 504. The coil 500 is located wholly within one IPT transmitter coil 7 with the clockwise and counter-clockwise portions 502,504 positioned on either side of a line of asymmetry 506 through the transmitter coil 7 so that different amounts IPT flux passes through each portion 502,504. In this example, the IPT flux through the oppositely-wound portions 502,504 may be balanced by using an imbalanced number of turns in each portion 502,504 calculated to substantially compensate for the IPT flux imbalance or an imbalanced impedance by configuring the relative size (e.g., thickness, diameter, etc.) or conductivity (e.g., by using different conductive materials) of the coil portion windings 502,504 calculated to substantially compensate for the IPT flux imbalance. Like the example of FIG. 3, the oppositely-wound portions 502,504 may be formed as separate windings that are coupled to one another or as a single winding wound in a (substantially asymmetrical or skewed) “FIG. 8” configuration.

Other forms of decoupling may be used depending on the application. It is noted that in embodiments where one or more excitation coils separate from the transmitter coil(s) are used for generating the detection field, it is the excitation coils that are wound in the flux-cancelling manner described above, whereas in embodiments where one or more transmitter coils are used for generating the detection field, it is the detection coils that are wound in the flux-cancelling manner described above in order to provide decoupling from an IPT filed being generated from other transmitter coils in a transmitter coil array, for example.

Layout of Excitation and Detection Coils

In order to increase the sensitivity and/or decrease the manufacturing costs, several features in the OD coils may be provided.

An example of an array of the transmitting coils is shown in FIG. 6. Each transmitting or IPT coil 602 is provided around a number of systematically arranged IPT ferrite elements (cores) 604. The IPT coils 602 are arranged in a rectangular array structure and may be linear (2D), overlapping (as in FIG. 6) or 3 dimensionally (3D) arranged. The coil and array itself may be arranged to have a different geometrical or arbitrary shape. The (array of) ferrite cores are used to enhance the IPT field generated by the IPT coils 602 in a manner understood by those skilled in the art and may be arranged and dimensioned relative to the transmitter coil array as described in U.S. Provisional Patent Application No. 62/070,042 entitled System and Method for Power Transfer and filed Aug. 12, 2014, the entire contents of which are expressly incorporated herein by reference, so that the upper surface (relative to the z-axis of the IPT system which is orthogonal to the plane of the transmitter coils; along which the so-called “z-height” is defined as the distance between the transmitting and receiving coils of the IPT system) of each ferrite element protrudes from the IPT coils 602 or may be configured so that the upper surface of the ferrite elements are co-planar with, or beneath, the upmost plane of the transmitting coils surface. The ferrite elements may have a substantially flat or rounded upper surface. As described below, if such ferrite elements are present for the IPT array, they may also be advantageously used for the detection field.

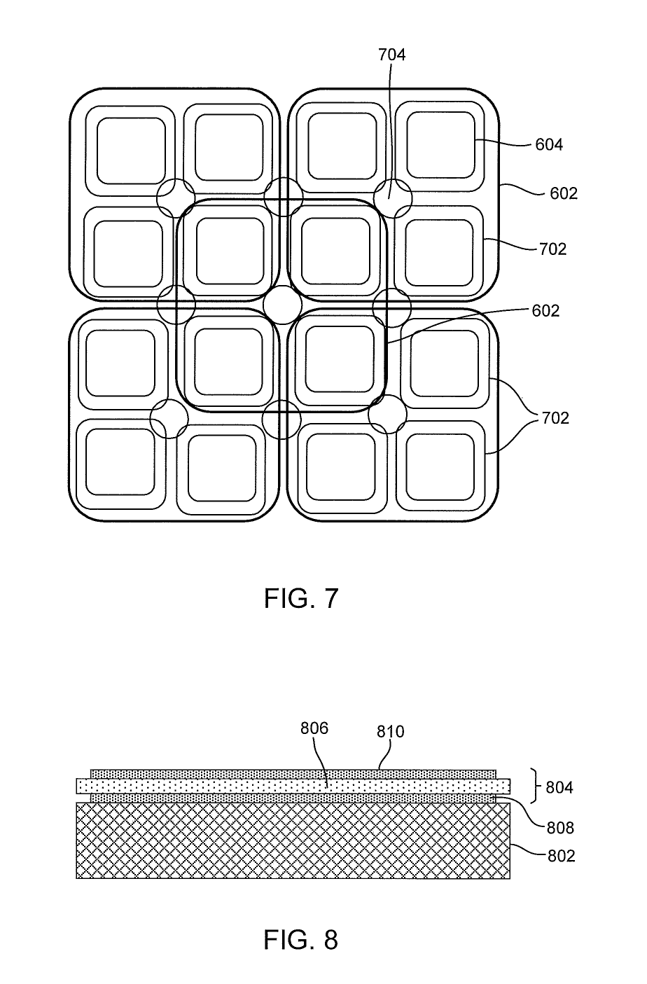

FIG. 7 shows the array of IPT coils 602 of FIG. 6 interleaved with an array of detection coils 702 in an example configuration. Each IPT coil 602 encompasses four of the ferrite cores 604. Each of the detection coils 702 is arranged above the upper surface of one of the ferrite cores 604 (i.e., in a plane which is parallel to, but elevated from, the plane of the upper surface of the ferrite element) so that the single ferrite core is surrounded by or enclosed within the respective detection coil, as seen in the aspect of FIG. 7. By this arrangement, the ferrite material of the core 604 allows the detection coil 702 to be more sensitive through enhancement of the OD field, similar to the effects in the IPT field. However, since the ferrite cores 604 concentrate the magnetic flux of the IPT field at the positions of the cores, the IPT flux in the spaces between the cores is correspondingly less dense. Accordingly, some areas may form IPT field nulls 704 with low, but non-zero, IPT flux. Similarly the sensitivity of the detection coils 702 also degrades between the ferrite cores 604. Thus the alignment of the IPT field nulls 704 and the lower sensitivity OD field regions may be desirable, as any foreign object present wholly at these points will similarly not be receiving IPT flux thereby reducing the risk of heating.

The excitation coil 202 may similarly be interleaved with the transmitting coils 7, and the ferrite elements 604 may be used to increase the OD field strength produced by the excitation coil array depending on the application requirements.

FIG. 8 shows the OD coil array constructed as a printed circuit board (PCB). A base layer 802 of a PCB 804 may have the array of transmitting coils and ferrite elements. The PCB 804 may include a substrate layer 806, with two copper trace layers 808 and 801 on either side. The underside trace 808 (facing the base layer 802) may include the excitation coils 202. The upper trace 810 may include the detection coils 204. In this way the size of the OD coil array can be minimised.

FIG. 9 shows an example field distribution 900, for the underside trace 808 in FIG. 8 where the excitation coils are arranged to surround each ferrite element 604 (in the manner discussed earlier with respect to the detection coils). The detection and/or excitation coils use the ferrite structure of the IPT transmitter coil array as described above and the field lines concentrate at the poles 902 of each ferrite element 604. In this embodiment, the ferrite elements 604 (and therefore the PCB 804) is provided on a base or substrate (back-plate) 904 also of ferrite. The base plate 904 therefore acts as shield for the undersides (with respect to the dimensional planes described earlier) of the IPT and OD coil arrays so that any metal objects underneath the coil arrays are not heated or erroneously detected. In this way, the OD circuit 200 is directional.

In this embodiment, the ferrite elements may be separate elements applied to the ferrite back-plate or integral with the back-plate through suitable manufacture. The OD coils may alternatively incorporate separate ferrite elements/cores to increase sensitivity of detection depending on the application, e.g., where the IPT coils array does not employ such elements.

Detection HW and Algorithm

As mentioned above the controller 8 of the transmitter 2 is directly or indirectly provided with the voltage from each detection coil and extracts the amplitude and phase against each location over time. For this purpose, the controller 8 may include an excitation coil driver and a detector circuit.

As discussed earlier, a means to discriminate between foreign objects and friendly objects, e.g., power receivers, is required. One method that may be used to discriminate the kind of object present, is measurement of the coupling factor between the excitation coils and the object above the transmission pad which is influencing the excitation (OD) field. The Applicant found that objects comprising mostly metal tend to suppress the coupling (lower voltage amplitude output) with the OD field, whereas objects having a relatively significant amount of ferrite tend to enhance the coupling (higher voltage amplitude output), and that resonant structures, such as power receivers having resonant pick-up or secondary circuits, tend to induce a phase shift in the backscatter signal. Thus, it is possible to distinguish ‘friendly’ objects, such as the ferrite shielding of an inductive pickup coil, from ‘foreign’ objects, such as coins, if these characteristics in the OD field behaviour are suitably determined.

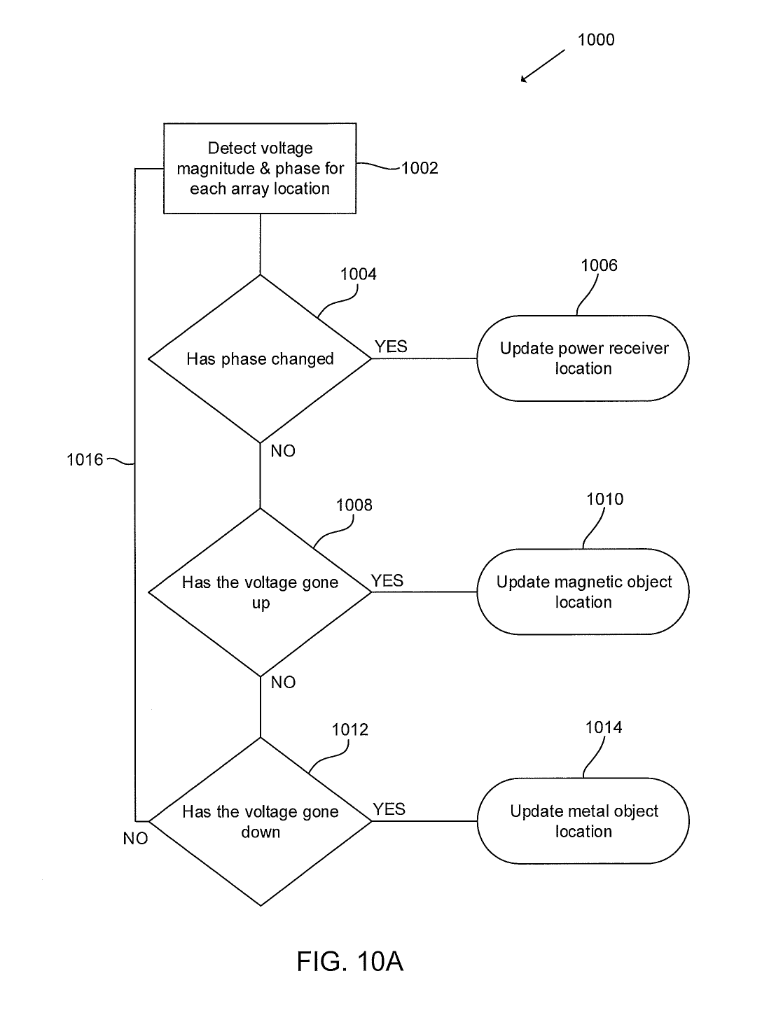

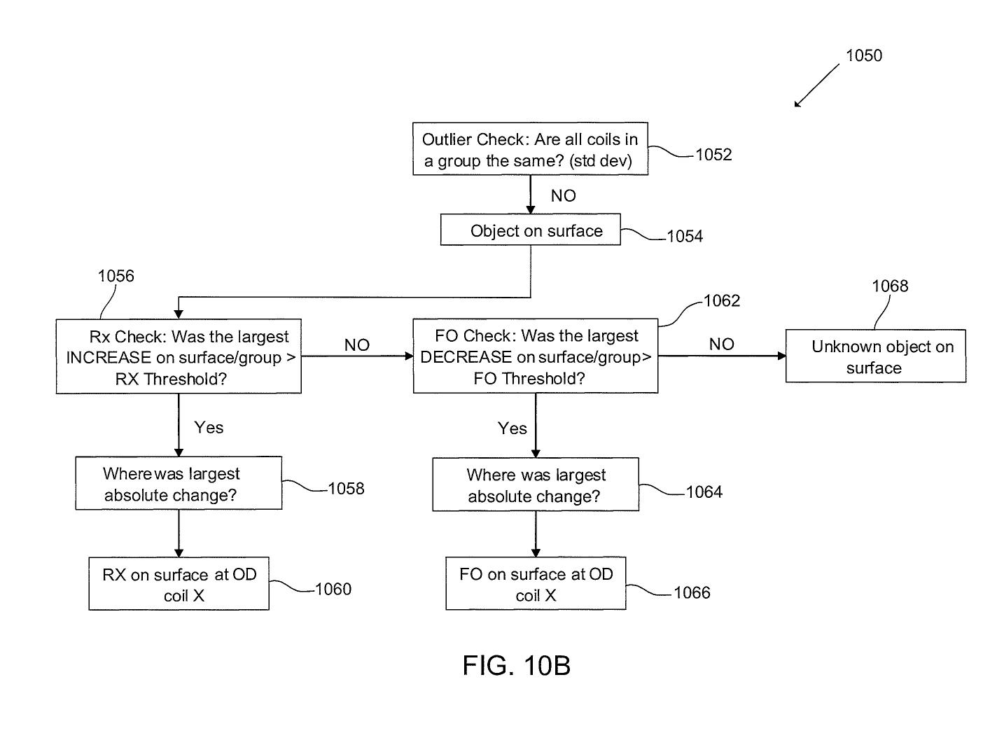

FIG. 10A shows an example algorithm 1000 for detecting objects. The controller 8 determines at step 1002 the voltage magnitude and phase at each location in the OD array. If at any location the phase has changed (step 1004), this location is updated at step 1006 to indicate that a power receiver is present. If the phase has not changed but the magnitude has increased (step 1008), this location is updated at step 1010 to indicate that a magnetic material is present. If the magnitude has not increased but has decreased (step 1012), this location is updated at step 1014 to indicate that a metal material is present. The determination continues (step 1016) for each location in the OD array and is then repeated either continuously, periodically or on the occurrence of a predefined event or events.

The algorithm 1000 of FIG. 10A illustrates an example where the detection of receivers and foreign objects is relatively simply provided by determining the relative magnitude and phase changes. Whilst these changes are present in many various scenarios, the amount of change may be difficult to distinguish from environmental and/or circuitry electronic noise. The changes may also be indistinguishable in scenarios where both a receiver and a foreign object are present. FIG. 10B shows another example algorithm 1050 for additionally facilitating detection of objects in such situations.

The algorithm 1050 recognises that there may be some variation in the measurements at ambient (i.e., no objects present) conditions across certain groups of the detection coils 702 and uses these groups to provide a measure of the standard deviation. The Applicant has found that these groups comprise neighbouring detection coils and are generally representative of the general topology of the coil array with the variations being due to manufacturing processes and tolerances. For example, the array may represent a polygon having more than four edges where sub-polygons having four or less edges defined therein provide the different detection coil groups, e.g., if the array is ‘cross-shaped’ (12-edged polygon), three four-edged polygons could be defined therein, such that three detection coil groups are defined in which the coils within each group have substantially consistent characteristics with the other coils in that group but may have different characteristics from the coils of the other groups. This grouping of coils allows differences in (magnitude and/or phase) measurements across the coils within those groups to be made with reasonable certainty in the accuracy of the measurements, thereby providing reliable detection of objects.

Accordingly in FIG. 10B, the controller 8 determines at step 1052 the standard deviation of the polar magnitude represented by the voltage magnitude and phase within each group of the OD array in a manner understood by those skilled in the art. If the standard deviation is within normal parameters, the controller 8 continues sampling the OD array either continuously, periodically or at defined events, as previously described. However, if within any group the standard deviation is more than a certain threshold amount (e.g., predetermined based on the known manufacturing tolerances) it is determined that one or more objects are in proximity of the charging surface (step 1054). Controller 8 then calculates a ratio of the current (i.e., t(n)) measurement of the polar magnitude and the (immediately) previous (i.e., t(n−1)) measurement of the polar magnitude as in Equation (1) for each detection coil within the group determined to have the object(s) therein or for all detection coils of the OD array. This ratio represents a change on the surface at a set location.

Ratioₜ₍ₙ₎=Polar Magnitudeₜ₍ₙ₎/Polar Magnitudeₜ₍ₙ₋₁₎ (1)

The controller 8 then runs a series of checks to detect the type of object(s) present based on the calculated ratios. At step 1056, a check for receiver(s) is performed by determining whether the largest ratio increase within the group (or surface) is greater than a receiver detection threshold, and if ‘yes’ the location of the largest ratio increase is determined (step 1058) and the location of the receiver at the determined detection coil is reported (step 1060) such that power transfer can be commenced using the IPT array. If the result of step 1056 is ‘no’ then at step 1062, a check for foreign object(s) is performed by determining whether the largest ratio decrease within the group (or surface) is greater than a foreign object detection threshold, and if ‘yes’ the location of the largest ratio decrease is determined (step 1064) and the location of the foreign object at the determined detection coil is reported (step 1066) such that power transfer using the IPT array is not enabled. If the result of step 1062 is ‘no’ then at step 1068, it is determined that an unknown object is present such that power transfer using the IPT array is not enabled. This ‘unknown’ object may represent a combination of a receiver and foreign object by the suitable selection of the receiver and foreign object thresholds. Such selection may be made through the measurement and modelling of various scenarios in a manner understood by those skilled in the art.

It is understood that the illustrated and described sequence of steps in FIGS. 10A and 10B are merely exemplary, and the sequences may be altered or replaced with parallel steps as appropriate.

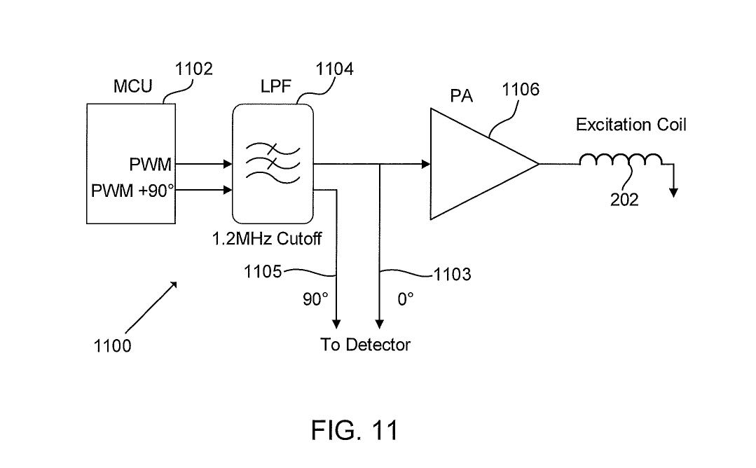

FIG. 11 shows an example of an excitation coil driver 1100. An MCU 1102 provides a PWM 1103 at the desired OD field frequency e.g.: 5 kHz/1 MHz (or range of frequencies of 1 kHz to 10 kHz/800 kHz to 1.2 MHz), as well as a 90° phase shifted signal 1105. Both signals are low pass filtered using a filter 1104 to create a sine wave from the PWM square wave by removing the harmonics and the filtered signals are provided to the detector (described later). A power amplifier 1106 scales the signal to the excitation coil 202 by a sufficient amount so that a good signal to noise ratio is provided, while not using excessive power.

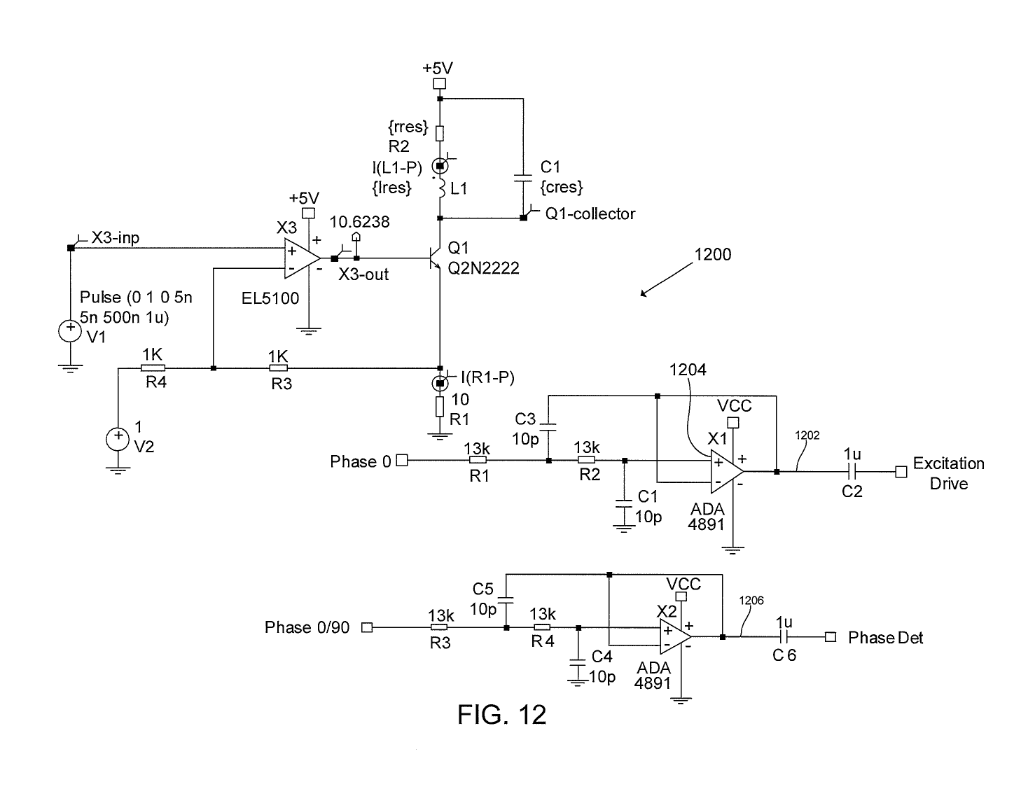

FIG. 12 shows another example circuit for the excitation coil driver circuit 1200. Two identical signal chains are used—one chain 1202 drives the excitation coil 202 using an operational amplifier (opamp) 1204 with a high drive capability. The other chain 1206 drives the controller (detector). The MCU 1102 can change the phase of the drive signal to the detector chain 1206, relative to the excitation chain 1202. In this way a 0° or 90° reference can be presented to the detector (described later).

Alternatively the actual excitation output is fed to a phase splitter (e.g.: R/C and C/R network) to generate two signals at 90° phase to each other, then an electronic switch is used to select one or the other.

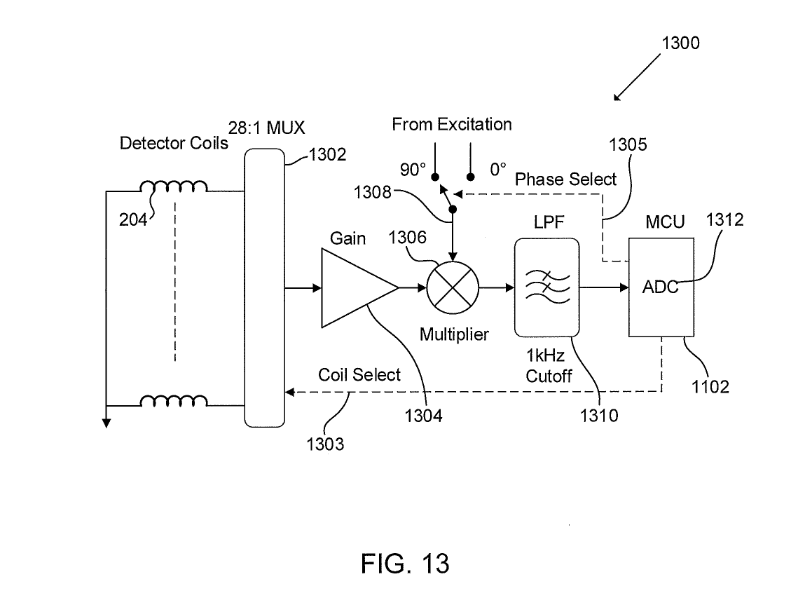

FIG. 13 shows an example of a detector 1300 which has the detection coil array. Each detection coil 204 is connected to a multiplexer 1302.

The multiplexer 1302 is either programmed with the signal 1303 to cycle through all of the detection coils continuously or periodically or may focus on certain detection coils where an object has been detected. The multiplexer output is amplified by amplifier 1304 and the excitation signal (voltage) described above is phase switched using switch 1305 by software in the MCU 1102 as described above. The amplified multiplexer output is mixed by a mixer 1306 (multiplied) with the two different phase switched excitation voltages 1308 from the excitation driver. Alternatively the mixing could be done by a DSP or microprocessor. The output of the mixer is low pass filtered by a filter 1310 and digitally sampled by an ADC 1312. The filter 1310 response determines the rate at which the detection coils can be switched, so the settling time should be selected according to application requirements on resolution of the OD field sampling.

This configuration of mixing and/or multiplexing has the advantage of tracking the frequency of the excitation without requiring variable filters. Further, the phase switching allows the MCU 1102 to extract amplitude and phase information from the digital signal. Because the voltage from the excitation coil(s) is the same frequency as the voltage from the detection coil(s), multiplying the two signals results in one composite signal comprised of one shifted up to double the frequency and one at DC. The low pass filter 1310 filters out the higher frequency signal. Then by phase shifting the excitation reference voltage by 90° and taking a second reading of the DC level, the phase can then be calculated at as the inverse tan of the division of the magnitudes of the two mixer DC outputs, for example using Equation (2):

$${tan}^{- 1} \frac{[ 0 deg ]}{[ 90 deg ]} \qquad ( 2 )$$

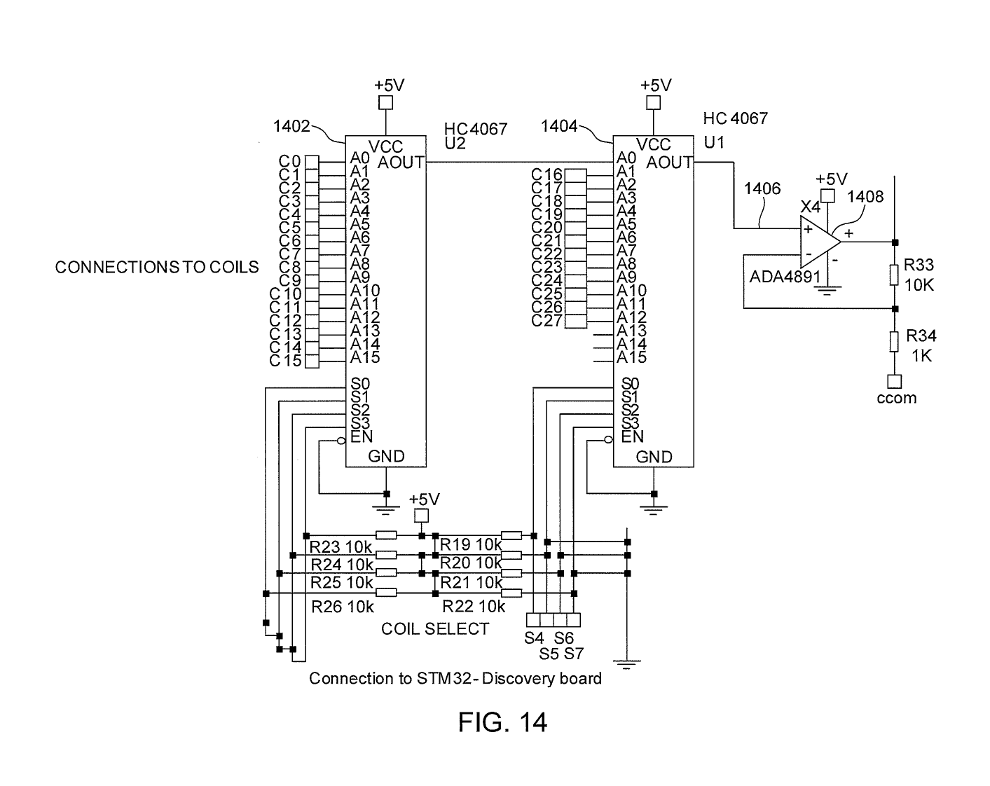

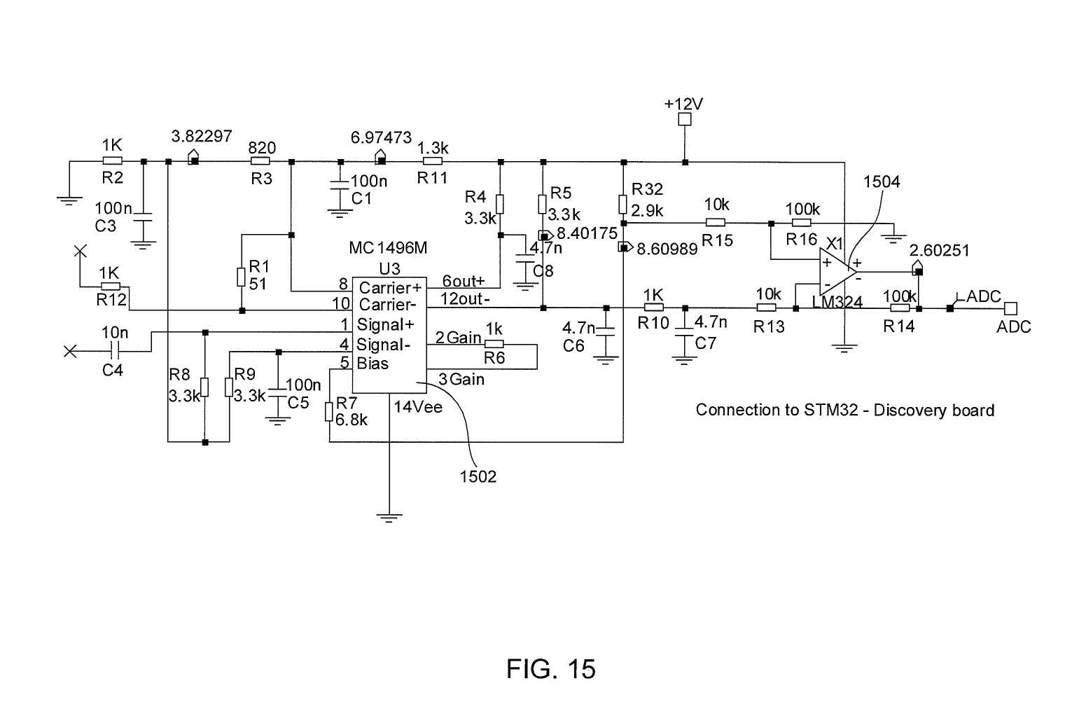

FIGS. 14 and 15 show an example circuit for the detector. The output of every detector coil 204 is connected to the inputs of one or more multiplexers 1402,1404 connected in series, with the eventual output 1406 amplified by an opamp 1408. The opamp 1408 output is passed to a Gilbert cell mixer 1502. This is followed by an amplifier 1504 providing both gain and DC offset to suit the input range of the ADC 1312.

The excitation/detection coils can be continuously driven so as to provide a continuous OD field, as the power consumption is low (about 10 mW). Alternatively, the OD field can be pulsed, which may lower the power consumption even more.

As absolute measurements are taken from the detection field, since it is decoupled from the IPT field, it is possible that if a foreign object is already present on the transmitter ‘pad’ at start-up this foreign object will not be detected but will merely be part of the ambient environment. A calibration token which is either physical (e.g., a metal disc) or digital (e.g., a calibration factor) of known properties may be used to calibrate the transmitter prior to use to avoid this, by locating it in set locations and adjusting the algorithm output until the location and object type are correctly determined.

Alternatively prior to use, relative phase and amplitude measurements between the primary, excitation and detection coils can be compared to relative expected values to determine anything unusual in the start-up environment. This can either generate an alert to manually check the environment or can be used to adjust the algorithm.

In a further alternative a calibration factor could also be determined by injecting a known signal into the system either through the existing coils or through an extra coil(s) at a certain spacing. This may avoid the need for manual calibration and/or a calibration object outside the system (e.g., a calibration token).

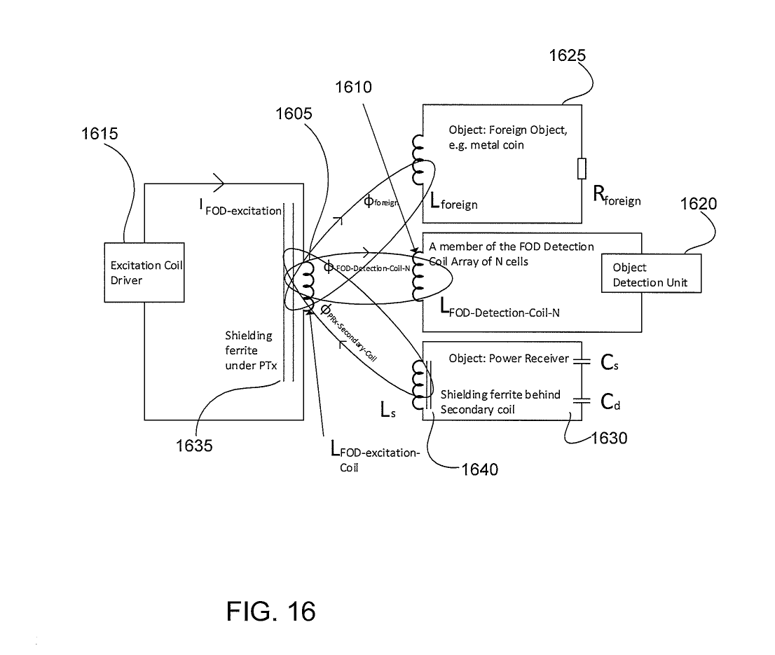

A further embodiment is described with respect to FIG. 16 and which includes some combinations of the forgoing features. Powering multiple receivers from a single transmitter array increases the dynamic range of the problem of detecting Foreign Object power dissipation in the presence of PRx (inductive power receiver) power transfer. This is because support for multiple PRx units increases the associated total PTx (inductive power transmitter) power transfer level substantially.

Spatial measurements (localised to a space approximating one PRx) provide a way to constrain the dynamic range of the problem, as additional Power Receivers are added to the Power Transmitter Product.

Evaluation of the complex impedances or a measurement of the coupling factor at each detector coil or cell in an array of detection coils, distributed spatially across the Interface Area (a transmitter surface for placing receivers), can provide useful indication of:
Object Detection when (and where) an object placed on the Interface Surface;
Whether the object is substantially metal in nature;
Whether the object contains ferrite;
Whether the object has a resonant circuit such as an L-C parallel resonant tank.

The embodiment described here may be used independently or in conjunction with other methods of Foreign Object Detection.

Referring to FIG. 16, the object detection system comprises the following system blocks:
a) An FOD Excitation Coil (1605) consisting of a conductor or array of conductors (this may be separate and decoupled from the Primary Coil) placed to cover the Interface Area or Surface such that applied current(s) produce magnetic flux through the plane of the Interface Area. The conductor(s) may be placed in a ‘double counter wound loop’ configuration so that flux linkages (to counter-wound sections of the same conductor), from the Primary Coil, minimise the net induced voltage;
b) An FOD Detection Coil Array (1610) consisting of an array of cells spatially distributed across the Interface Surface. Each cell contains a conductor(s) configured such that any magnetic flux generated by the FOD Excitation Coil that links with (i.e. passes through) an object placed near or on the Interface Surface, will also link with the conductor in at least one cell of the FOD Detection Coil Array;
c) An Excitation Coil Driver (1615) circuit that applies a continuous or pulsed excitation current to the FOD Excitation Coil;
d) An Object Detection Unit (1620) that measures and evaluates the complex impedances at each cell of the FOD Detection Coil Array. Typically this would be comprised of a measurement circuit that processes signals from each cell such that they can be evaluated by a numerical computation unit.

Also shown are a foreign object (1625) and a valid inductive power receiver (1630). The ferrite shielding for each of the excitation coil (at 1635) and the receiver (at 1630) are also shown, and advantageously employed to detect a valid receiver (1630).

The embodiment may evaluate each cell's output vector magnitude or polar magnitude as a measure of complex impedance is as follows:
1. Apply excitation current I_{FOD-excitation}, by enabling the Excitation Coil Driver. The magnitude and frequency of I_{FOD-excitation} (in conjunction with system implementation attributes) are arranged to produce sufficient levels of flux in φ_{foreign}, φ_{FOD-Detection-Coil-N} (at each cell), φ_{PRx-Secondary-Coil} such that the Object Detection System can evaluate complex impedance (by determining a measure of complex impedance) of the two different object groups (foreign object or valid receiver), with sufficient accuracy to distinguish between them. The frequency of I_{FOD-excitation} is typically a point close to, but not exactly equal to, the resonant detection frequency f_{d} formed by Lₛ, Cₛ, and C_{d} in a PRx (1630);
2. For each cell (1610) in the FOD Detection Coil Array, apply a termination impedance and measure the amplitude and phase of the voltage signal at each L_{FOD-Detection-Coil-N}—implemented by the object detection circuit (1620)—a measure of complex impedance.
3. Amplitude can be evaluated by measuring the components of the cell output signal that are in-phase, and in quadrature with a local reference (such as the Excitation Coil Driver output). The vector or polar magnitude can be evaluated as the root of the sum of the squares of the in-phase and quadrature components that were measured. Similarly the vector phase angle can be evaluated by computing the inverse or arc tangent of the ratio of the in-phase component divided by the quadrature component. However other methods of determining these measurements could alternatively be used.

Detection of the presence and type of an object using a measure of complex impedance at the detection coils can be performed as follows:
1. Record “empty board” tare values (E.g. at power-on of the transmitter) by evaluating each cell's output vector magnitude when there are no objects on the Interface Surface;
2. Periodically compute σ_{FOD-Detection-Coils}² the statistical variance (ie standard deviation squared) of cell output vector magnitudes (ie measures of complex impendences) in the array (use net value after subtracting tare values for each cell);
3. If σ_{FOD-Detection-Coils}² is below a threshold k_{array}_{_}_{change}, then remain idle and return to step 2. Threshold k_{array}_{_}_{change} may be established by prior experiment with the final system implementation;
4. Evaluate the ratio Nₛₗₒₚₑ_{_}_{cell}_{_}_{N} for each cell output vector magnitude divided by the previous measurement for that cell;
5. If Nₛₗₒₚₑ_{_}_{cell}_{_}_{N} is above a threshold kₛₗₒₚₑ_{_}_{PRXfound}_{_}ₘᵢₙ, then a valid PRx has been found. Threshold kₛₗₒₚₑ_{_}_{PRXfound}_{_}ₘᵢₙ may be established by prior experiment with the final system implementation;
6. If Nₛₗₒₚₑ_{_}_{cell}_{_}_{N} is below a threshold kₛₗₒₚₑ_{_}_{PRXfound}_{_}ₘₐₓ, then a foreign object (or both a foreign object and a PRx together) has been found. Threshold kₛₗₒₚₑ_{_}_{PRXfound}_{_}ₘₐₓ may be established by prior experiment with the final system implementation;
7. This survey can be repeated at alternate frequencies of I_{FOD-excitation} for improved accuracy.

In alternative arrangements, the power coil of the transmitter may also be used as the excitation coil of the object detection system. Similarly the excitation coil may not be decoupled from a separate power coil of the transmitter. Whilst an array of detection coils has been employed, a single detection coil may alternatively be used. As a further alternative, the power coils may be employed as the detection coils. Furthermore different measures of complex impedance may be used. Also different types (in addition to receiver and foreign object) may be detected using the measures of complex impedance.

Whilst the embodiment has been described as detecting a receiver type of object in response to determining an increase in polar magnitude above a receiver detection threshold (ie Nₛₗₒₚₑ_{_}_{cell}_{_}_{N}>kₛₗₒₚₑ_{_}_{PRXfound}_{_}ₘᵢₙ), a more generic relationship to the polar magnitude could be used such as a change within a predetermined range. Similarly, whilst detection of a foreign object type of object has been described as being in response to a decrease in polar magnitude above a foreign object detection threshold (ie Nₛₗₒₚₑ_{_}_{cell}_{_}_{N}<kₛₗₒₚₑ_{_}_{PRXfound}_{_}ₘₐₓ), a more generic relationship to the polar magnitude could be used such as a change within a second predetermined range.

The measure of complex impedance may be determined from in-phase and quadrature voltage components of the detection coil(s). This may be determined by a combination of analogue circuit components and digital processing—ie the polar magnitude.

The object detection algorithm may only be executed if a “significant” change in measurements is detected in order to improve accuracy in accounting for differences and/or changes in parameters of the coils in practice. This may be configured to occur when a calculated statistic variance of the change from a predetermined measure of complex impedance (eg the “empty board” values) in the detection coils (or a sub-group of these) is above a statistic variance detection threshold (ie σ_{FOD-Detection-Coils}²>k_{array}_{_}_{change}).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An object detection system for an inductive power transmitter and comprising:
an excitation coil;
a detection coil;
the system arranged to determine a measure of complex impedance at the detection coil in response to application of an excitation current to the excitation coil;
the system further arranged to detect the presence of an object and a type of the object using the measure of complex impedance.

2. The object detection system of claim 1, further arranged to detect one or more of the following:
a first type of object at the detection coil in response to a change in a phase of the complex impedance;
a second type of object in response to a change in magnitude of the complex impedance;
a third type of object in response to a reduction in magnitude of the complex impedance above a threshold.

3. The object detection system of claim 1, further arranged to detect one or more of the following:
a receiver type of object at the detection coil in response to determining a change in the polar magnitude of the measure of complex impedance within a first predetermined range;
a foreign object type of object at the detection coil in response to determining a change in a polar magnitude of the measure of complex impedance within a second predetermined range.

4. The object detection system of claim 3, wherein determining changes in the polar magnitude of the measure of complex impedance within a first predetermined range comprises determining an increase in the polar magnitude of the measure of complex impedance above a receiver detection threshold; and wherein determining changes in the polar magnitude of the measure of complex impedance within a second predetermined range comprises determining a decrease in a polar magnitude of the measure of complex impedance above a foreign object detection threshold.

5. The object detection system of claim 4, wherein determining an increase or decrease in polar magnitude is determined by calculating a ratio of a current measure of polar magnitude and a previous measure of polar magnitude.

6. The object detection system of claim 1, wherein the measure of complex impedance is determined from in-phase and quadrature voltage components of the detection coil.

7. The objection detection system of claim 1, further comprising an array of a plurality of detection coils in order to allow the system to determine a measure of complex impedance at each detection coil.

8. The object detection system of claim 7, further arranged to calculate a statistical variance of the change from a predetermined measure of complex impedance in a group of the detection coils, and wherein the system is arranged to detect the presence and type of object in response to statistical variance being above a statistical variance detection threshold.

9. An inductive power transmitter comprising an object detection system according to claim 1.

10. The inductive power transmitter of claim 9, and comprising at least one power transmitting coil configured to generate an inductive power transfer (IPT) field; wherein the object detection system is substantially decoupled from the IPT field.

11. The inductive power transmitter of claim 10, wherein the excitation coil(s) and/or the detection coil(s) are double counter wound loops configured for substantially even flux from the IPT field in each loop.

12. The inductive power transmitter of claim 9, and comprising at least one power transmitting coil configured to generate an inductive power transfer (IPT) field; wherein the object detection system uses the power transmitting coil as the excitation coil.

13. The inductive power transmitter of claim 9, wherein inductive power transfer between the transmitter and a receiver is controlled depending on detection of the presence of an object and a type of the object by the object detection system.

14. An inductive power transmitter comprising:
at least one power transmitting coil configured to generate an inductive power transfer (IPT) field; and
an object detection system configured to detect objects in or adjacent to the IPT field;
wherein the object detection system is substantially decoupled from the IPT field.

15. The transmitter in claim 14, wherein the object detection system is substantially frequency decoupled from the IPT field, or substantially magnetically decoupled from the IPT field.

16. (canceled)

17. The transmitter of claim 14, wherein the object detection system comprises one or more excitation coils and one or more detection coils, wherein the net magnetic flux from the IPT field through the excitation coil(s) and/or the detection coil(s) is minimised.

18. The transmitter in claim 17, wherein the excitation coil(s) and/or the detection coil(s) are selected from the group consisting of:
a double counter wound loop configured for substantially even flux from the IPT field in each loop;
a single wound loop configuration for substantially even amounts of opposing flux from the IPT field; and
a double counter wound loop with uneven loop sizes and/or uneven number of turns in each loop configured for substantially uneven flux density from the IPT field in each loop.

19. The transmitter in claim 17, wherein a plurality of nulls in the IPT field are configured to substantially coincide with areas of lower sensitivity of the detection coil(s).

20. The transmitter in claim 17, wherein each excitation coil(s) and/or detection coil(s) is located around a respective IPT magnetic core associated with the at least one transmitting coil.

21.-30. (canceled)

31. A method of detecting the presence and a type of an object proximate an inductive power transmitter, and comprising:
determining a measure of complex impedance at a detection coil in response to application of an excitation current to an excitation coil, both coils proximate the inductive power transmitter;
detecting the presence of an object and the type of the object using the measure of complex impedance.

32. (canceled)
